(19) United States
(12) Patent Application Publication
(10) Pub. No.: US 2020/0184619 A1
(43) Pub. Date: Jun. 11, 2020

(54) ARTICLE INSPECTION INFORMATION MANAGEMENT APPARATUS, PROGRAM FOR THE SAME, AND ARTICLE INSPECTION SYSTEM

(71) Applicant: ANRITSU INFIVIS CO., LTD., Kanagawa (JP)

(72) Inventor: Osamu TAKATA, Kanagawa (JP)

(21) Appl. No.: 16/701,569

(22) Filed: Dec. 3, 2019

(30) Foreign Application Priority Data
Dec. 5, 2018 (JP) 2018-227895

(51) Int. Cl. G06T 7/00; G06F 3/0482

(52) U.S. Cl. CPC G06T 7/001; G06T 2207/30128; G06F 3/0482

(57) ABSTRACT

To increase reliability of a determination in operation modes different from in normal inspection of an article inspection apparatus by displaying information that can be checked by a manager with respect to a determination of the article inspection apparatus operated in the operation modes different from in the normal inspection and storing a checking result of the manager. There is provided a host computer 71 that acquires and manages inspection information from an X-ray inspection apparatus 30, a metal detection apparatus 40, and a weight inspection apparatus 50 inspecting an article to be produced via a computer network 70, in which the host computer 71 displays a screen from which a determination is checkable by a manager on a display unit 73 and stores checking information input by the manager in correlation with the inspection information when the inspection information is output through the determination during an operation checking mode.

### TECHNICAL FIELD

The present invention relates to an article inspection information management apparatus managing inspection information of an article inspection apparatus that inspects the quality of an inspection object such as meat, fish, processed food, and medicine, a program for the article inspection information management apparatus, and an article inspection system.

### BACKGROUND ART

For example, in a production line producing, for example, meat, fish, processed food, or medicine, products manufactured in a manufacturing line are sent to an inspection line so as to be subjected to inspection of containing of foreign substances or inspection of final weights, and products determined as being non-defective products through the inspection are shipped as final products.

Patent Document 1 discloses an article inspection apparatus that accumulates inspection result data such as a quality determination result of each inspection object, a detection signal during inspection, and a time, causes a desired extraction condition to be selected from a plurality of stored extraction conditions, and extracts and displays inspection result data satisfying the selected extraction condition. In the article inspection apparatus, in addition to an inspection result, an operation history of information regarding a running situation and the presence or absence of an abnormal state is recorded with respect to time, an event (running situation), and the details thereof.

### RELATED ART DOCUMENT

### [Patent Document]

[Patent Document 1] JP-A-2013-113612

### DISCLOSURE OF THE INVENTION

### Problem that the Invention is to Solve

However, for example, as an event, in a case where operation checking or reinspection in an operation mode requiring a determination different from in normal inspection is performed by a worker, the fact and a result thereof are recorded as an operation history, but information regarding whether or not the worker has correctly performed the operation checking or the reinspection is not recorded in the operation history. Particularly, the correctness in a case where the worker has performed the operation checking or the reinspection alone, that is, whether or not the operation checking or the reinspection has been approved by a manager is not recorded.

In recent years, quality management in a production line has been enhanced, and thus there is the need not only for recording of inspection results but also for recording of reliability or certainty of an event such as operation checking or reinspection different from normal inspection.

Therefore, the present invention is directed to increasing reliability of determination in an operation mode different from in normal inspection of an article inspection apparatus by a manager displaying information to be checked with respect to determination in the article inspection apparatus operated in the operation mode that is performed through a worker's operation and is different from in the normal inspection, and storing the manager's checking result.

### Means for Solving the Problem

According to the present invention, there is provided an article inspection information management apparatus that manages inspection information which is output from an article inspection apparatus inspecting an article to be produced and includes an inspection result in which quality of the article is determined, and an operation mode when the determination is performed, the article inspection information management apparatus including a display unit; an input unit with which the manager inputs information; and a control unit that displays a checking screen displaying an item to be checked by a manager with respect to the inspection information on the display unit and stores checking information that is input to the input unit by the manager in correlation with the inspection information, in a case of operation modes other than a normal inspection mode in which normal inspection is performed as the operation mode when the inspection information is received.

With this configuration, an item to be checked by a manager with respect to inspection information in operation modes different from in normal inspection in an article inspection apparatus, performed by a worker, is displayed, and checking information that is input by the manager is stored in correlation with the inspection information. Thus, since inspection data determined in operation modes different from normal inspection is displayed, and the manager inputs a result of checking the display thereof, it is possible to quickly find a work error of a worker performing an operation different from normal inspection, and thus reliability of a determination in operation modes different from the normal inspection is increased.

In the article inspection information management apparatus of the present invention, the control unit displays the checking screen displaying the item to be checked by the manager with respect to the inspection information on the display unit and stores checking information that is input to the input unit by the manager in correlation with the inspection information, in a case where the operation mode is an operation checking mode in which a sample is transported and it is checked whether or not an apparatus is correctly operated when the inspection information is received.

With this configuration, since, with respect to operation checking for an article inspection apparatus, performed by a worker, inspection data in which the quality of the operation checking has been determined is displayed, and a manager inputs a result of checking the display thereof, it is possible to quickly find a work error of a worker performing the operation checking, and thus reliability of the operation checking is increased.

According to the present invention, there is provided a program for an article inspection information management apparatus that manages inspection information which is output from an article inspection apparatus inspecting an article to be produced and includes an inspection result in which quality of the article is determined, and an operation mode when the determination is performed, the program causing a computer to execute a checking information adding function of displaying a checking screen displaying an item to be checked by a manager with respect to the inspection information and storing checking information that is input by the manager in correlation with the inspection information, in a case of operation modes other than a normal inspection mode in which normal inspection is performed as the operation mode when the inspection information is received.

With this configuration, an item to be checked by a manager with respect to inspection information in operation modes different from in normal inspection in an article inspection apparatus, performed by a worker, is displayed, and checking information that is input by the manager is stored in correlation with the inspection information. Therefore, reliability of a determination in operation modes different from the normal inspection is increased.

According to the present invention, there is provided an article inspection system including the article inspection information management apparatus according to claim 1; and an article inspection apparatus that is connected to the article inspection information management apparatus and inspects an article to be produced.

With this configuration, reliability of a determination in operation modes different from the normal inspection in the article inspection apparatus connected to the article inspection information management apparatus is increased.

### Advantage of the Invention

According to the present invention, it is possible to increase reliability of determination in an operation mode different from in normal inspection of an article inspection apparatus.

### BRIEF DESCRIPTION OF THE DRAWINGS

FIG. 1 is a schematic configuration diagram illustrating an article inspection system according to an embodiment of the present invention.

FIG. 2 is a schematic block diagram illustrating an article inspection information management apparatus according to the embodiment of the present invention.

FIG. 3 is a diagram illustrating an example of an inspection image display screen of the article inspection system according to the embodiment of the present invention.

FIG. 4 is a diagram illustrating an example of an image checking screen of the article inspection system according to the embodiment of the present invention.

FIG. 5 is a diagram illustrating an example of an inspection image display screen to which checking information is input, of the article inspection system according to the embodiment of the present invention.

FIGS. 6A to 6C are diagrams illustrating examples of images displayed on an image display unit of the article inspection system according to the embodiment, in which FIG. 6A illustrates an example of a case of an X-ray inspection apparatus, FIG. 6B illustrates an example of a case of a weight inspection apparatus, and FIG. 6C illustrates an example of a case of a metal detection apparatus.

### BEST MODE FOR CARRYING OUT THE INVENTION

Hereinafter, with reference to the drawings, an article inspection system according to an embodiment of the present invention will be described in detail.

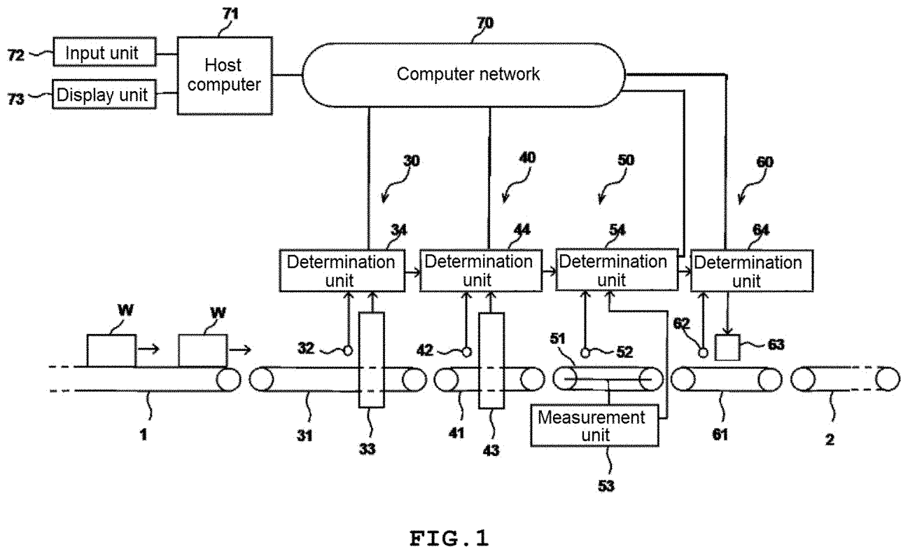

In FIG. 1, an article inspection system according to the embodiment of the present invention manages an inspection line in which inspection of containing of foreign substance and inspection of a weight is performed on an article W such as food carried out from a conveyor 1 of a manufacturing line, the article W determined as a non-defective product is carried out to a conveyor 2 of the subsequent shipment line, and an article determined as a defective product is excluded from the line.

The inspection line is configured to include an X-ray inspection apparatus 30, a metal detection apparatus 40, a weight inspection apparatus 50, and a sorting machine 60. The inspection line may be configured to include any one of the X-ray inspection apparatus 30, the metal detection apparatus 40, and the weight inspection apparatus 50, and may be configured to include two or more thereof.

Each of the X-ray inspection apparatus 30, the metal detection apparatus 40, and the weight inspection apparatus 50 performing inspection in the inspection line is operated in a plurality of operation modes. The operation modes include not only a normal inspection mode that is a normal operation mode in which quality determination is performed through inspection, but also an operation checking mode and a reinspection mode.

The operation checking mode is a mode in which a sample for operation checking is transported, and it is checked whether or not an apparatus is correctly operated through a determination, and modes may be switched manually through a direct operation on article inspection apparatus or through an operation based on externally remote connection or the like and may be switched automatically by recognizing a sample for operation checking. The reinspection mode is performed in a case where an article determined as being required for reinspection is transported again, and is inspected again by changing an inspection criterion or a case where an article determined as being defective is transported again to be inspected again, and a calculated result of the article recorded already is corrected.

The X-ray inspection apparatus 30 is configured to include a conveyor 31, an article sensor 32, an X-ray detection unit 33, and a determination unit 34.

The conveyor 31 receives the article W carried out from the conveyor 1 of the manufacturing line on one end side thereof, and transports the article W to the other side thereof.

The article sensor 32 is disposed right before the X-ray detection unit 33, detects entry of the article W to the X-ray detection unit 33, and outputs a detection signal to the determination unit 34. The article sensor 32 is configured with, for example, a transmissive photoelectric sensor including a pair of a light emitter and a light receiver (not illustrated) disposed to face each other and to cross the conveyor 31 in a width direction (front and rear directions in FIG. 1).

The X-ray detection unit 33 is configured to irradiate the article W detected by the article sensor 32 with a wide X-ray parallel to a surface orthogonal to a transport direction of the conveyor 31, to detect the X-ray transmitted through the article W with an X-ray line sensor, and to output a signal representing a transmission quantity at each position to the determination unit 34.

The determination unit 34 crates image data representing a difference between X-ray transmission quantities at each position of the article W according to movement of the article W due to the conveyor 31 on the basis of a signal output from the X-ray detection unit 33, and determines containing of a foreign substance or the presence or absence of a difference on the basis of the image data.

The determination unit 34 transmits information including an operation mode, a determination result, the image data detected by the X-ray detection unit 33, and the like, as inspection information, to a host computer 71 via a computer network 70. The determination unit 34 outputs a determination for excluding an article corresponding to an operation mode different from in a determination result to the subsequent metal detection apparatus 40 as inspection result information.

The metal detection apparatus 40 inspects the presence or absence of containing of foreign metal with respect to the article W carried out from the X-ray inspection apparatus 30, and is configured to include a conveyor 41, an article sensor 42, a magnetic detection unit 43, and a determination unit 44.

The conveyor 41 receives an article carried out from the conveyor 31 on one end side thereof, and transports the article to the other end side thereof. The conveyor 41 may also be used as the conveyor 31 of the X-ray inspection apparatus 30.

The article sensor 42 is disposed right before the magnetic detection unit 43, detects the article W right before entering the magnetic detection unit 43, and outputs a detection signal to the determination unit 44. The article sensor 42 is configured with, for example, a transmissive photoelectric sensor including a pair of a light emitter and a light receiver (not illustrated) disposed to face each other and to cross the conveyor 41 in a width direction (front and rear directions in FIG. 1).

The magnetic detection unit 43 generates a magnetic field on the conveyor 41, and detects a change in the magnetic field due to the article W passing through the magnetic field. The metal detection apparatus 40 may have a configuration in which metal contained in the article W is magnetized by a magnetizer such as a magnet, and residual magnetism of the magnetized metal is detected by a magnetic sensor.

The determination unit 44 determines whether or not foreign metal is contained in the article W on the basis of a signal output from the magnetic detection unit 43 with respect to the article W detected by the article sensor 42.

The determination unit 44 transmits, as inspection information, an operation mode, a determination result, temporal changes of an amplitude and a phase of a signal output from the magnetic detection unit 43, a determination target value obtained on the basis of a signal output from the magnetic detection unit 43, and the like, to the host computer 71 via the computer network 70. The determination unit 44 combines the determination for excluding an article corresponding to an operation mode different from in a determination result with the inspection result information received from the X-ray inspection apparatus 30, and outputs a combination result to the subsequent weight inspection apparatus 50 as new inspection result information of the inspected article W.

The weight inspection apparatus 50 inspects a weight of the article W carried out from the metal detection apparatus 40, and is configured to include a conveyor 51, an article sensor 52, a measurement unit 53, and a determination unit 54.

The conveyor 51 is disposed to function as a weighbridge used for the measurement unit 53 to measure a load of the article W with a load sensor, and receives the article W carried out from the preceding conveyor 41 on one end side thereof, and transports the article W to the other end side thereof.

The article sensor 52 detects the article W carried into the conveyor 51, and outputs a detection signal to the determination unit 54. The article sensor 52 is configured with, for example, a transmissive photoelectric sensor including a pair of a light emitter and a light receiver (not illustrated) disposed to face each other and to cross the conveyor 51 in a width direction (front and rear directions in FIG. 1).

The measurement unit 53 outputs a weight signal corresponding to a load of the article W that is detected by the article sensor 52 and is placed on the conveyor 51, to the determination unit 54.

The determination unit 54 obtains a weight of the article W on the basis of the weight signal output from the measurement unit 53 after the article W detected by the article sensor 52 is completely carried out to the conveyor 51, and determines whether or not the obtained weight is within an allowable range.

The determination unit 54 transmits, as inspection information, an operation mode, a determination result, the weight signal output from the measurement unit 53, the obtained weight value, and the like, to the host computer 71 via the computer network 70. The determination unit 54 combines the determination for excluding an article corresponding to an operation mode different from in a determination result with the inspection result information received from the metal detection apparatus 40, and outputs a combination result to the subsequent sorting machine 60 as new inspection result information of the inspected article W.

The sorting machine 60 excludes an article determined as being excluded in each preceding inspection apparatus from the line among the articles W carried out from the weight inspection apparatus 50, and is configured to include a conveyor 61, an article sensor 62, an exclusion device 63, and a determination unit 64.

The conveyor 61 receives the article W carried out from the preceding conveyor 51 on one end side thereof, transports the article W to the other end side thereof, and carries out the article W to the conveyor 2 of the shipment line. The conveyor 61 may also be used as the conveyor 2 of the shipment line.

The article sensor 62 is disposed right before the exclusion device 63, detects the article W carried out to the conveyor 61 right before the exclusion device 63, and outputs a detection signal to the determination unit 64. The article sensor 62 is configured with, for example, a transmissive photoelectric sensor including a pair of a light emitter and a light receiver (not illustrated) disposed to face each other and to cross the conveyor 61 in a width direction (front and rear directions in FIG. 1).

The exclusion device 63 excludes the article W on the conveyor 61 from the line whenever a defect signal is received from the determination unit 64.

As the exclusion device 63, there may be the use of a device that blows air to the article W from a lateral side of the conveyor 61 to be excluded from the conveyor 61, a device that guides the article W to the lateral side of the conveyor 61 through turning of a lever or sliding to be excluded, or the like.

The determination unit 64 extracts the information regarding the determinations for excluding an article from the inspection result information received from the weight inspection apparatus 50, outputs a defect signal to the exclusion device 63 when a determination regarding an article to be excluded is included in any one thereof, and excludes the article W detected by the article sensor 62 from the conveyor 61.

Each apparatus of the inspection line with the configuration is communicable with the host computer 71 via the computer network 70, and the host computer 71 collects and manages information from each apparatus.

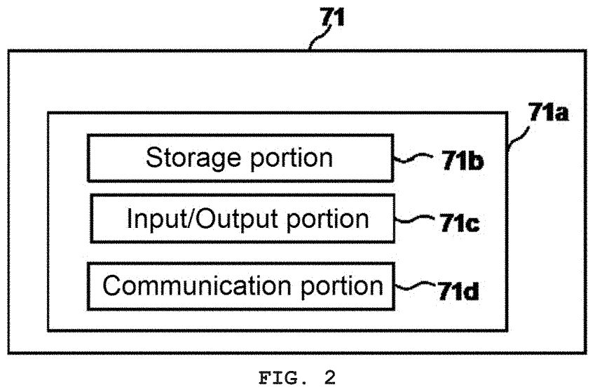

The host computer 71 is configured with a central processing unit (CPU), a random access memory (RAM), a read only memory (ROM) (not illustrated), and a computer unit 71a as a control unit including a storage device such as a hard disk device serving as a storage portion 71b illustrated in FIG. 2, an input/output portion 71c having input and output ports, and a communication portion 71d connected to the computer network 70 and performing communication, and realizes various functions by executing a stored program.

The input unit 72 is connected to the input port of the host computer 71. The input unit 72 includes, for example, a keyboard or a mouse.

The display unit 73 is connected to the output port of the host computer 71. The display unit 73 includes, for example, a liquid crystal display.

The host computer 71 stores and manages inspection information, or a calculated number of non-defective products or defective products into the hard disk device on the basis of the information from each apparatus of the inspection line, received via the communication portion 71d.

The host computer 71 may store and manage, into the hard disk device, an operation history including inspection information in a normal inspection mode of each apparatus of a plurality of inspection lines or inspection information in operation modes other than the normal inspection mode, the number of non-defective products, the number of defective products, and the like.

The host computer 71 handles image data detected by the X-ray detection unit 33 of the X-ray inspection apparatus 30 or inspection information such as an influence value of the metal detection apparatus 40, which is output through a determination during an operation checking mode, as inspection information regarding an inspection result required to be checked by a manager, and stores and manages checking information of the manager in the hard disk device in correlation with the inspection information.

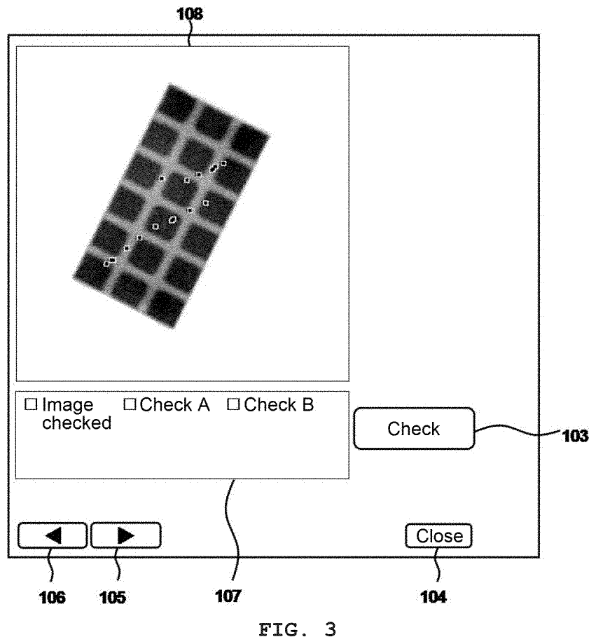

In a case where inspection information is output through a determination during an operation checking mode in each apparatus of the inspection line, and the inspection is received, the host computer 71 immediately displays a screen from which the determination is to be checked by the manager on the display unit 73, and displays, on the display unit 73, an inspection image display screen as illustrated in FIG. 3, including an X-ray inspection image for the article W by using the article W as a sample for operation checking.

In FIG. 3, a check button 103 is used to check a check state of an inspection result which will be described later. A close button 104 is used to close the inspection image display screen.

A next display button 105 is used to display an X-ray inspection image for the next article W. A previous display button 106 is used to display an X-ray inspection image for the previous article W.

Contents set through checking of an inspection result which will be described later are displayed in a check state display portion 107. An X-ray inspection image for the article W is displayed in an image display portion 108.

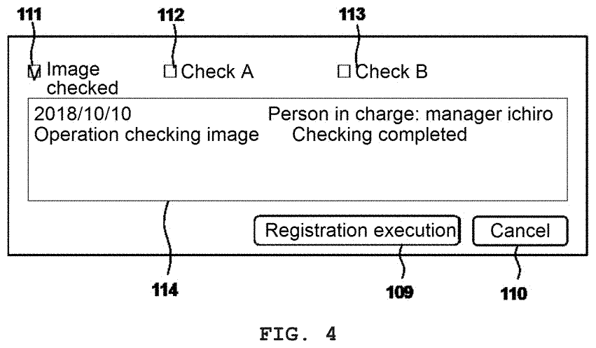

In a case where the check button 103 is selected through an operation on the input unit 72, the host computer 71 displays an image checking screen as illustrated in FIG. 4.

In FIG. 4, a registration execution button 109 is used to store a check state of a checkbox which will be described later or input contents in a manager checking portion 114 in correlation with inspection information of the corresponding article W.

A cancel button 110 is used not to store a check state of the checkbox which will be described later or input contents in the manager checking portion 114.

An image-checked checkbox 111 is used to input whether or not the manager has checked a defect through operation checking on the basis of an image displayed on the image display portion 108.

A check A checkbox 112 is used to input whether or not a predetermined check A has been performed or whether or not a predetermined state occurs.

A check B checkbox 113 is used to input whether or not a predetermined check B has been performed or whether or not a predetermined state occurs.

Display names or the like of the check A checkbox 112 and the check B checkbox 113 may be changed according to a user's definition. For example, the article W required to be checked by another manager may be checked.

The manager checking portion 114 is used to input checking information of a manager having performed defect checking work through operation checking on the basis of an image displayed on the image display portion 108. The checking information of a manager is information desired to be left, for example, information regarding a checking result of whether or not a defect has been checked through operation checking by the manager or a comment for a displayed image.

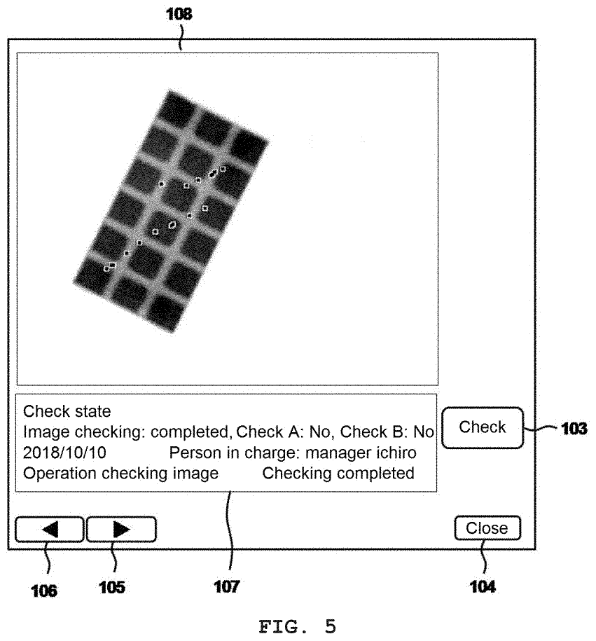

As illustrated in FIG. 4, in a case where a check mark is input in a checkbox, a manager has input checking in the manager checking portion 114, and the registration execution button 109 is selected through an operation using the input unit 72, the host computer 71 stores an input check state of the checkbox or input contents in the manager checking portion 114 in correlation with inspection information of the corresponding article W, and displays an inspection image display screen as illustrated in FIG. 5.

As illustrated in FIG. 5, the check state of the checkbox or the input contents in the manager checking portion 114 are displayed in the check state display portion 107.

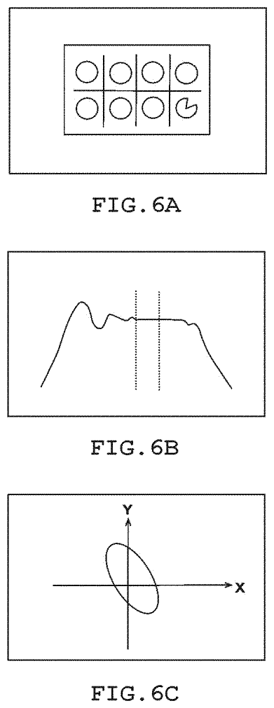

In a case of the X-ray inspection apparatus 30, an X-ray transmission image is displayed on the image display portion 108 as illustrated in FIG. 6A.

In a case of the metal detection apparatus 40, as illustrated in FIG. 6C, a Lissajous's waveform generated on the basis of temporal changes of an amplitude and a phase of a signal output from the magnetic detection unit 43 is displayed.

In a case of the weight inspection apparatus 50, as illustrated in FIG. 6B, an image in which a temporal change of a weight is displayed as a waveform is displayed. A weight of the article W is obtained at a timing (in the figure, a timing between two dashed lines) at which a weight signal from the measurement unit 53 is stabilized.

As mentioned above, since inspection information such as an inspection image of the article W is displayed by using a sample for operation checking that is output through a determination during an operation checking mode, and a check state of a checkbox or an input content in the manager checking portion 114 is stored in correlation with the inspection information, a work error of a worker checking an operation can be quickly found, and thus it is possible to increase reliability of a determination in an operation mode different from in normal inspection.

A description has been made of a case where an operation mode is an operation checking mode, but, in the same manner for a case where an operation mode is a reinspection mode, an inspection image or the like for the determined article W may be displayed, and a manager may input checking. However, an inspection result in this case cannot be said to show a defect. A calculated result, recorded already, corresponding to the article W inspected again may be changed by the manager inputting checking.

The host computer 71 may extract inspection information, or a calculated number of non-defective products or defective products from each apparatus of the inspection line, received via the communication portion 71d, according to an extraction condition that is input through an operation using the input unit 72, and may display a list thereof on the display unit 73, and may display a list of check statuses of a manager for each determination result of operation checking, for example, in a case where the extraction condition is a determination result of operation checking.

An inspection image display screen is displayed by using the input unit 72 and the display unit 73 connected to the input and output ports of the host computer 71, and manager checking information is input, but an operation may be performed through a portable terminal apparatus wirelessly connected to the host computer 71. In the above-described way, even though a manager is present at a location separated from an inspection apparatus or a host computer, the manager can perform quick checking, and can thus quickly find a work error of a worker performing operation checking.

A program of the present invention operates in the host computer 71, and inspection information including an inspection result in which the quality of an article is determined and an operation mode when the determination is performed is output from the determination unit 34, 44, and of the article inspection apparatus 30, 40, and 50 inspecting the produced article, and is received by the host computer 71 via the computer network 70. The program operating in the host computer 71 is configured to receive and manage the inspection information.

When the inspection information is received in operation modes other than a normal inspection mode in which normal inspection is performed as the operation mode, the program causes a computer to realize a checking information adding function of displaying a checking screen on which an item to be checked by a manager is recognizable with respect to the inspection information on the display unit 73 at predetermined timing, and storing the checking information that is input from the input unit 72 by the manager into the host computer 71 or a storage device (not illustrated) provided on the computer network 70 in correlation with the received inspection information. In FIG. 1, the host computer receives inspection information via the computer network 70, but the article inspection apparatus 30, 40, and 50 (determination unit 34, 44, and 54) may be directly connected to the host computer 71.

The embodiment of the present invention has been disclosed, but it is obvious that a person skilled in the art can add modifications thereto without departing from the scope of the present invention. All such modifications and equivalents are intended to be included in the following claims.

### DESCRIPTION OF REFERENCE NUMERALS AND SIGNS

30 X-ray inspection apparatus (article inspection apparatus)
40 Metal detection apparatus (article inspection apparatus)
50 Weight inspection apparatus (article inspection apparatus)
70 Computer network
71 Host computer (article inspection information management apparatus)
71a Computer unit (control unit)
72 Input unit
73 Display unit
114 Manager checking portion

What is claimed is:

1. An article inspection information management apparatus that manages inspection information which is output from an article inspection apparatus inspecting an article to be produced and includes an inspection result in which quality of the article is determined, and an operation mode when the determination is performed, the article inspection information management apparatus comprising:
a display unit;
an input unit with which the manager inputs information; and
a control unit that displays a checking screen displaying an item to be checked by a manager with respect to the inspection information on the display unit and stores checking information that is input to the input unit by the manager in correlation with the inspection information, in a case of operation modes other than a normal inspection mode in which normal inspection is performed as the operation mode when the inspection information is received.

2. The article inspection information management apparatus according to claim 1,
wherein the control unit displays the checking screen displaying the item to be checked by the manager with respect to the inspection information on the display unit and stores checking information that is input to the input unit by the manager in correlation with the inspection information, in a case where the operation mode is an operation checking mode in which a sample is transported and it is checked whether or not an apparatus is correctly operated when the inspection information is received.

3. A program for an article inspection information management apparatus that manages inspection information which is output from an article inspection apparatus inspecting an article to be produced and includes an inspection result in which quality of the article is determined, and an operation mode when the determination is performed, the program causing a computer to execute:
a checking information adding function of displaying a checking screen displaying an item to be checked by a manager with respect to the inspection information and storing checking information that is input by the manager in correlation with the inspection information, in a case of operation modes other than a normal inspection mode in which normal inspection is performed as the operation mode when the inspection information is received.

4. An article inspection system comprising:
the article inspection information management apparatus according to claim 1; and
an article inspection apparatus that is connected to the article inspection information management apparatus and inspects an article to be produced.
